(19) United States
(12) Patent Application Publication
(10) Pub. No.: US 2025/0361128 A1
(43) Pub. Date: Nov. 27, 2025

(54) Debris and Fluid Entry Prevention Systems for Jack Cylinders

(71) Applicant: Harbor Freight Tools USA, Inc., Calabasas, CA (US)

(72) Inventor: Andrew McGraw, Newbury Park, CA (US)

(21) Appl. No.: 18/672,964

(22) Filed: May 23, 2024

(51) Int. Cl. B66F 5/04; F16J 15/52

(52) U.S. Cl. CPC B66F 5/04; F16J 15/52; B66F 2700/123

(57) ABSTRACT

An ingress prevention system for use with pneumatic or hydraulic jack cylinders prevents debris and/or fluids from gaining access to portions of the pneumatic or hydraulic jack cylinders. The ingress prevention system includes a boot operable to retain and/or seal at least a portion of one or more jack cylinders within a boot cavity. The ingress prevention system reduces a jack cylinder's exposure to debris and/or fluids to maintain performance and prolong the operating life of the jack cylinder. The ingress prevention system further comprises at least one barrel seal operable to wipe debris and/or fluids from the surfaces of a piston rod as the piston rod reciprocates within a barrel.

### BACKGROUND

The present disclosure relates generally to ingress prevention systems for use with pneumatic or hydraulic jacks such as a floor jack.

Floor jacks generally include at least one pneumatic or hydraulic jack cylinder activated by pumping a handle. Actuation of the jack cylinder(s) drives a ram, creating a lifting force for a movement arm. These jack cylinders typically utilize a piston rod and barrel configuration, which may be exposed to elements such as debris and/or fluids present in the environment. Given the reciprocating motion of the piston rod within the barrel, debris and/or fluids deposited on the surfaces of the piston rod or barrel may enter the cylinder and compromise the fluid pressure or seals within the jack cylinder or may lead to abrasion on the surfaces of the piston rod or the barrel. Exposure to such debris and/or fluids often results in decreased performance of the jack cylinders requiring increased pumping of the handle to lift the same load, or, a loss of the ability to lift any load. For example, air may leak into a jack cylinder causing the jack cylinder to not function properly.

To reduce exposure debris and/or fluids, some floor jacks incorporate a jack cylinder shield that covers an end of the piston rod as it reciprocates within the barrel. These jack cylinder shields are often insufficiently effective at minimizing exposure to debris and/or fluids due to incomplete coverage or an incomplete seal of the jack cylinder within the shield. Therefore, it is advantageous to provide an ingress prevention system that substantially eliminates exposure to debris and/or fluids to improve the performance and prolong the operating life of a jack cylinder.

### SUMMARY

An ingress prevention system for use with pneumatic or hydraulic jacks is disclosed, as illustrated by and described in connection with the figures of the present disclosure, and as set forth in the claims.

Specifically, disclosed is an example ingress prevention system for use with pneumatic or hydraulic jacks. The ingress prevention system includes a jack cylinder including a piston rod, a barrel, and a piston rod cap, wherein the barrel is operable to receive at least a portion of the piston rod. The jack cylinder further includes a rod end proximate an exposed end of the piston rod and a barrel end proximate a jack base. The ingress prevention system further includes a boot. The boot includes a boot cavity operable to receive at least a portion of the jack cylinder, a top end including an annular rim defining an annular rim opening, and a bottom end including a barrel opening and an annular lip defining a planar surface. The ingress prevention system further includes a flange disposed around at least a portion of the boot near the bottom end and positioned adjacent the annular lip of the boot. In this example, the boot is flexible, the annular rim is operable to retain at least a portion of the rod end of the jack cylinder within the boot cavity, and the flange is operable to maintain contact between portions of the annular lip and the jack base.

In one example, the ingress prevention system further includes a spring at least partially surrounding the barrel and the piston rod and a head of the piston rod secured to the piston rod cap, wherein the piston rod cap is covering at least a portion of the spring, barrel, and piston rod. The ingress prevention system further includes a rod opening of the piston rod cap being concentric with the annular rim opening. In another example, the annular rim opening is sized smaller than the piston rod cap to retain the rod end of the jack cylinder within the boot cavity.

In another example, a bottom surface of the flange mates with the planar surface of the annular lip to maintain contact between the annular lip and the jack base. In one example, the ingress prevention system further includes a groove disposed on an inner surface of the barrel and a barrel seal disposed within the groove, the barrel seal operable to wipe debris and/or fluids from the piston rod as the piston rod reciprocates within the barrel. In another example, the ingress prevention system further includes a barrel seal secured to an end of the barrel, the barrel seal operable to wipe debris and/or fluids from the piston rod as the piston rod reciprocates within the barrel.

Also disclosed is an ingress prevention system for use with jack cylinders. The ingress prevention system includes a jack cylinder including a piston rod and a barrel, wherein the barrel is operable to receive at least a portion of the piston rod and securely fastened to a jack base with a threaded engagement. The ingress prevention system further includes a spring at least partially surrounding the barrel and the piston rod and a boot. The boot includes a boot cavity operable to receive at least a portion of the barrel, the piston rod, and the spring. The boot further includes a top end including an annular rim defining an annular rim opening. The boot further includes a bottom end including a barrel opening and an annular lip. In this example, the boot is flexible. The ingress prevention system further includes a flange threadedly engaged with at least a portion of the barrel near the jack base.

In one example, the annular rim is adjacent to a retaining ring and at least one boot seal, wherein the retaining ring and the at least one boot seal are operable to seal the top end of the boot. In another example, the flange includes a lip cavity disposed on an inner surface of the flange, the lip cavity operable to receive at least a portion of the annular lip. In another example, the barrel includes a port operable to regulate air pressure within the boot cavity. In another example, the barrel further includes a filter disposed within a hollow bore of the port.

In one example, the ingress prevention system further includes a groove disposed on an inner surface of the barrel and a barrel seal disposed within the groove, the barrel seal operable to wipe debris and/or fluids from the piston rod as the piston rod reciprocates within the barrel. In another example, the ingress prevention system further includes a barrel seal secured to an end of the barrel, the barrel seal operable to wipe debris and/or fluids from the piston rod as the piston rod reciprocates within the barrel.

Also disclose is an example ingress prevention system for use with jack cylinders. The ingress prevention system includes a plurality of jack cylinders, each including a piston rod and a barrel, wherein the barrel is operable to receive at least a portion of the piston rod, wherein each of the plurality of jack cylinders further includes a rod end proximate an exposed end of the piston rod and a barrel end proximate a jack base. The ingress prevention system further includes a boot. The boot includes a boot cavity operable to receive at least a portion of each of the plurality of jack cylinders. The boot further includes a top end including an annular rim defining a piston rod opening and a plate cavity disposed within the annular rim. The boot further includes a plate disposed at least partially within the plate cavity of the annular rim. The boot further includes a bottom end including a barrel opening and an annular lip defining a planar surface. In this example, the boot is flexible. The ingress prevention system further includes a flange disposed around at least a portion of the boot and positioned adjacent the annular lip of the boot, the flange secured to the jack base with a plurality of fasteners.

In one example, the ingress prevention system further includes a plurality of springs each at least partially surrounding the barrels and the piston rods. The ingress prevention system further includes a plurality of piston rod caps, the plurality of piston rod caps secured to a head of each of the piston rods and covering at least a portion of the springs, the barrels, and the piston rods. In another example, the plate includes a plurality of openings operable to receive each of the exposed ends of the plurality of jack cylinders.

In another example, the ingress prevention system further includes a groove disposed on an inner surface of each of the barrels and a barrel seal disposed within the groove, the barrel seal operable to wipe debris and/or fluids from the piston rods as the piston rods reciprocate within the barrels. In yet another example, the ingress prevention system further includes a barrel seal secured to an end of each of the barrels, the barrel seal operable to wipe debris and/or fluids from the piston rods as the piston rods reciprocate within the barrels.

Also disclosed is an example ingress prevention system for use with jack cylinders. The ingress prevention system includes a jack cylinder including a piston rod and a barrel, wherein the barrel is operable to receive at least a portion of the piston rod. The ingress prevention system further includes a spring at least partially surrounding the barrel and the piston rod. The ingress prevention system further includes a piston rod cap secured to a head of the piston rod and covering at least a portion of the spring, the barrel, and the piston rod. The ingress prevention system further includes a boot disposed between the spring and the piston rod. The boot includes a boot cavity operable to receive at least a portion of the barrel and the piston rod. The boot further includes a top end including a piston rod opening, the top end operable to retain at least a portion of the piston rod within the boot cavity. The boot further includes a bottom end including a barrel opening operable to at least partially receive the barrel, the bottom end operable to retain at least a portion of the barrel within the boot cavity.

In one example, the boot includes a flexible portion near the top end and a stiff portion near the bottom end having a clamp to secure the bottom end of the boot to the barrel. In another example, wherein the piston rod cap comprises a shield, a retaining ring, and a retaining clip, wherein the retaining clip is operable to secure the retaining ring to the piston rod. In another example, the ingress prevention system further includes a groove disposed on an inner surface of the barrel and a barrel seal disposed within the groove, the barrel seal operable to wipe debris and/or fluids from the piston rod as the piston rod reciprocates within the barrel.

### BRIEF DESCRIPTION OF SEVERAL VIEWS OF DRAWINGS

The following is a brief description of the drawings pertaining to the present disclosure, which will be discussed in more detail in the detailed description section below:

FIG. 1 illustrates a partially exploded perspective view of an ingress prevention system of a floor jack.

FIG. 2 illustrates a partial cut-away view of the floor jack, showing a lifting arm in a raised configuration and exemplary internal components of the floor jack.

FIG. 3 illustrates a close-up, partially exploded perspective view of the ingress prevention system, showing a jack cylinder to be retained within each boot.

FIG. 4 illustrates a cross sectional view of the ingress prevention system taken along lines 4-4 of FIG. 3.

FIG. 5 illustrates a cross sectional view of another embodiment of the ingress prevention system.

FIG. 6 illustrates a cross sectional view of another embodiment of the ingress prevention system.

FIG. 7 illustrates a perspective view of one embodiment of a barrel of the jack cylinder, showing a port.

FIG. 8 illustrates a cross sectional view of the ingress prevention system, showing the barrel with the port threadably engaged with the jack base.

FIG. 9 illustrates a partially exploded perspective view of another embodiment of the ingress prevention system, showing a jack cylinder to be retained within each boot.

FIG. 10 illustrates a cross sectional view of the ingress prevention system taken along lines 10-10 of FIG. 9.

FIG. 11 illustrates a partially exploded perspective view of another embodiment of the ingress prevention system, showing a plurality of jack cylinders to be retained within the boot.

FIG. 12 illustrates a cross sectional view of the ingress prevention system taken along lines 12-12 of FIG. 11.

FIG. 13 illustrates a partially exploded perspective view of another embodiment of the ingress prevention system, showing a boot to be positioned at least partially between a spring and a piston rod of the jack cylinder.

FIG. 14 illustrates a cross sectional view of the ingress prevention system taken along lines 14-14 of FIG. 13.

FIG. 15 illustrates a partially exploded view of a ram coupled to the lifting arm and a fluid reservoir of the floor jack, showing the ram and at least a portion of the reservoir positioned at least partially within a boot.

FIG. 16 illustrates an exploded perspective view of a barrel seal, the piston rod, the barrel, the spring, a piston rod cap, and a retaining ring.

FIG. 17 illustrates a cross sectional view of the piston rod received within the barrel and the barrel seal positioned with a groove on the barrel.

FIG. 18 illustrates an exploded perspective view of a barrel seal, the piston rod, the barrel, the spring, the piston rod cap, and the retaining ring.

FIG. 19 illustrates a cross sectional view of the piston rod received within the barrel and the barrel seal secured to a first end of the barrel.

FIG. 20 illustrates an exploded view of a ram seal.

FIG. 21 illustrates a cross sectional view of the ram seal taken along lines 21-21 of FIG. 20.

FIG. 22 illustrates a partially exploded view of the ram seal secured to a ram end of the fluid reservoir, showing the ram received within the ram seal and the fluid reservoir.

The foregoing summary, as well as the following detailed description of certain features of the present application, are better understood when read in conjunction with the appended drawings. For the purposes of illustration, certain features are shown in the drawings. It should be understood, however, that the claims are not limited to the arrangements shown in the attached drawings. Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of applications comprising one or more embodiments of the disclosure. As such, the drawings are not meant to include all conventional features known by those of ordinary skill in the art to be required for the practice of the embodiments disclosed herein.

### DETAILED DESCRIPTION

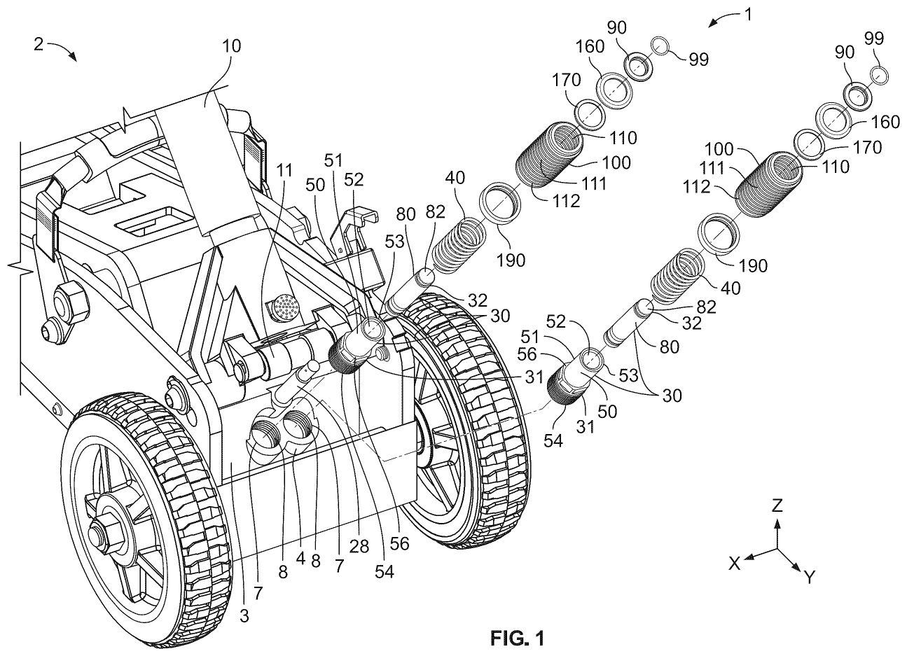

The present disclosure relates to an ingress prevention system 1 for use with pneumatic or hydraulic jacks, particularly, floor jacks. The ingress prevention system 1 prevents unwanted debris (e.g., dust, shavings, dirt, etc.) and fluids (e.g., water, oil, etc.) from entering portions of a floor jack 2, specifically the pneumatic or hydraulic jack cylinders. Preventing debris and/or fluids from gaining access to portions of the floor jack 2 increases the life span of the floor jack 2, and provides the user with an enhanced experience when using the floor jack 2. The floor jack 2 is shown in the partially exploded view of FIG. 1. Also shown in FIG. 1 are x, y, and z axes to assist in the description of the various movements and relationships of the components of the floor jack 2. The ingress prevention system 1 comprises a boot 100 operable to retain and/or seal a jack cylinder 30 within a boot cavity 110. The boot 100 is flexible, and includes a corrugated surface 111 with a plurality of folds 112 that allow the boot 100 to expand and collapse as a piston rod 80 of the jack cylinder 30 reciprocates within a bore 52 of a barrel 50. In some embodiments, the ingress prevention system 1 further comprises a flange nut 190. The flange nut 190 is operable to secure the boot 100 to the barrel 50 and/or a jack base 3. The present disclosure contemplates that the boot 100 is made of any suitable material that is substantially impervious to debris and/or fluids and that allows the boot 100 to expand and collapse. It is also to be understood that the present disclosure contemplates that the boot 100 is comprised of any suitable shape sufficient to retain and/or seal one or more jack cylinders 30 within the boot cavity 110.

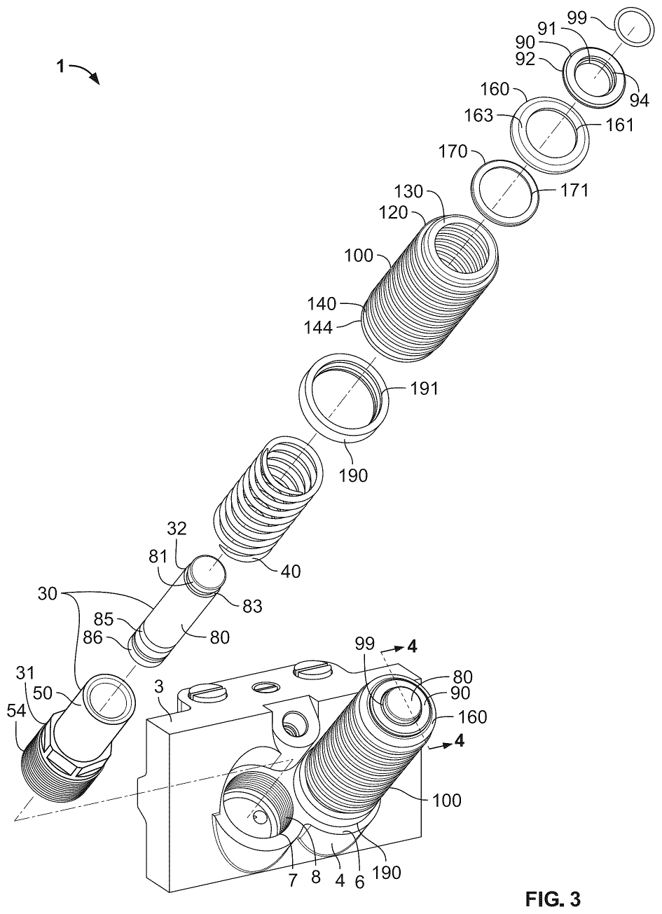

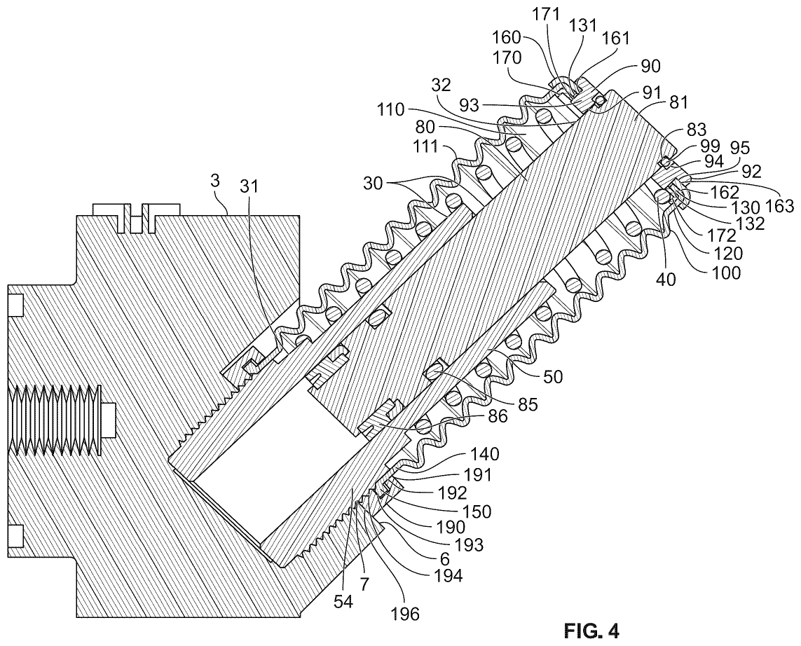

In the event the jack cylinder 30 is exposed to debris and/or fluids, such debris and/or fluids may cause abrasion to the surfaces of the piston rod 80 or the bore 52 of the barrel 50. The debris and/or fluids may also compromise a rod seal 85 or piston seal 86 (as shown in FIGS. 3 and 4), which maintain the fluid pressure within the jack cylinder 30. In alternative embodiments, the barrel 50 may include the same type of seals, such as multiple rod seals 85 or piston seals 86, near the rod end 32 and/or the barrel end 31. Additionally, alternative embodiments may include the barrel 50 having different types of seals located near the rod end 32 and the barrel end 31. Ultimately, exposure to such debris and/or fluids may lead to reduced fluid pressure within the jack cylinder 30 and a decreased lifting force. Furthermore, exposure to debris and/or fluids may also lead to abrasions on the jack cylinder 30, which may lead to oil bypass and air intake causing damage to the jack cylinder 30. As such, it is advantageous to reduce exposure to debris and/or fluids by retaining and/or sealing at least a portion of the rod end 32 and the barrel end 31 of the jack cylinder 30 within the boot cavity 110 of the boot 100.

As shown in FIG. 1, the ingress prevention system 1 further comprises the jack cylinder 30 that includes a rod end 32 proximate an exposed end 82 of the piston rod 80 and a barrel end 31 proximate the jack base 3. A spring 40 at least partially surrounds a portion of a first end 53 and a portion of the second end 54 of the barrel 50, as well as a portion of the piston rod 80. As shown, the barrel 50 includes a body 51 having a hex 56. The hex 56 is disposed between the first end 53 and the second end 54, proximate the second end 54. In alternative embodiments, the hex 56 may be other geometries, such as D-shape, flat, pin pockets, etc. The second end 54 of the barrel 50 is threaded and threadably engages a threaded inner surface 8 of a barrel opening 7 of a mount 4 to securely fasten the barrel 50 to the jack base 3. A tool (not shown), such as a wrench, is operable to engage with the hex 56 to thread the barrel 50 into the barrel opening 8 of the mount 4. In operation, pumping a handle 10 of the floor jack 2 engages a set of rollers 11 that actuate the jack cylinders 30 at the rod ends 32. The handle 10 is also operable to engage a release valve 28 to release pressure of the hydraulic fluid. The rollers 11 act on the rod end 32 of the piston rod 80 to keep the piston rod 80 retained in the barrel 50. When disassembled, the rollers 11 are removed and no longer retain the piston rod 80 in the barrel 50, the piston rod 80 may extend outwards, moving out of the barrel 50 until the spring 40 is no longer compressed. In addition to preventing debris and/or fluid from gaining access to portions of the floor jack 2, the ingress prevention system 1 may also prevent the piston rod 80 from coming out of the barrel 50 when the rollers 11 are no longer engaging the rod end 32, such as during disassembly.

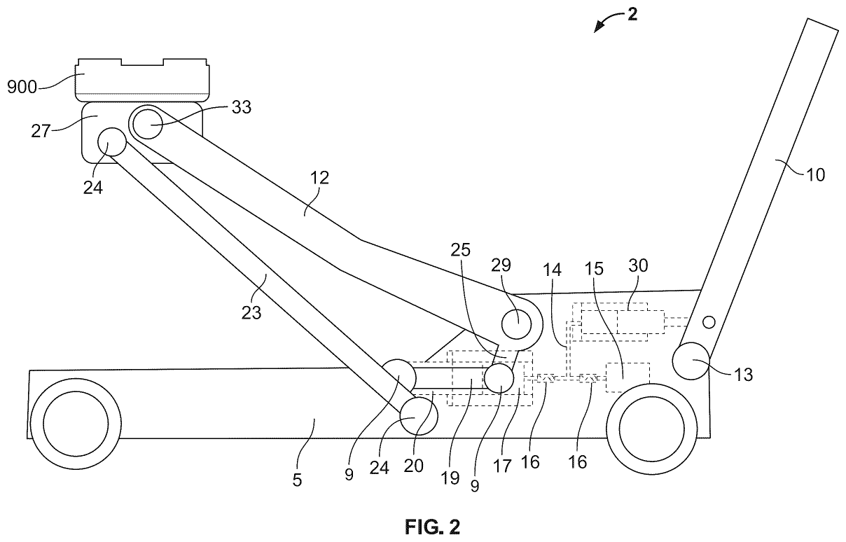

For example, FIG. 2 shows a partial cutaway view of the floor jack 2 in an upper extended position. As illustrated, the handle 10 is operable to raise the lifting arm 12 by repeatedly pumping handle 10 up and down (i.e., rotating the handle 10 about the handle pivot 13) to actuate at least one jack cylinder 30. Such pumping of the jack cylinder 30 builds up pressure of hydraulic fluid, which is transferred via a fluid conduit 14 from a low pressure reservoir 15 through one or more check valve(s) 16, into one or more fluid reservoirs 17. As pressure builds and more hydraulic fluid is transferred into the fluid reservoir 17, a ram 20 is driven outward, away from the handle 10. As shown, ram 20 is pivotably coupled to at least one link 19 via first link pivot 9. Link 19 is pivotably coupled to at least one rocker arm 25 via a second link pivot 9. Rocker arm 25 is fixed to, or integral with, the lifting arm 12. The lifting arm 12 pivotably couples to and pivots about the lifting arm pivot 29. As the ram 20 is driven outward, ram 20 acts on (i.e., pulls) link 19, which in turn causes the rocker arm 25 and lifting arm 12 to rotate about the lifting arm pivot 29. In the illustrated embodiment, lifting arm 12 is coupled to the mounting bracket 27 via an upper lifting arm pivot 33. Lever 23, which in some embodiments may be a radius arm, is pinned between a body 5 of the floor jack 2 and the mounting bracket 27 and assists in preventing rotation of mounting bracket 27. As shown, one end of the lever 23 is connected to the body 5 of the floor jack 2 via a first lever pivot 24 and the other end of the lever 23 is connected to the mounting bracket 27 via a second lever pivot 24. As the lifting arm 12 is raised, lever 23 rotates about the lever pivots 24, providing support for any load applied to the saddle jack 900 and mounting bracket 27. The ram 20 retracts and the lifting arm 12 is lowered when pressure is released from the fluid reservoir 17.

As shown in FIGS. 3-4, to retain the barrel end 31 of the jack cylinder 30 within the boot cavity 110, the second end 54 of the barrel 50 is positioned within a barrel opening 144 of a bottom end 140 of the boot 100. The diameter of the barrel opening 144 relative to the diameter of the barrel 50 is such that there is a tight interference fit between the barrel opening 144 and the second end 54 of the barrel 50. The bottom end 140 of the boot 100 is secured to the mount 4 by the flange nut 190. The flange nut 190 is circular and includes a cylinder opening 191 operable to receive at least a portion of the boot 100 and the barrel 50. As best seen in FIG. 4, the cylinder opening 191 defines an inner surface 192, a lip cavity 193, and a threaded inner surface portion 194. The lip cavity 193 receives an annular lip 150 of the bottom end 140 of the boot 100 in a tight interference fit such that exposure to debris and/or fluids is reduced in the space between the inner surface 192 of the flange nut 190 and the corrugated surface 111 of the boot 100. Further, threading the flange nut 190 onto the second end 54 of the barrel 50 via the threaded inner surface portion 194 secures the flange nut 190 (and therefore the boot 100) to the barrel 50. This brings a bottom surface 196 of the flange nut 190 in contact with a seat 6 of the mount 4 such that exposure to debris and/or fluids is reduced in the space between the barrel opening 7 of the jack base 3 and the bottom surface 196 of the flange. In alternative embodiments, the bottom surface 196 of the flange nut 190 may not be in contact with the seat 6 of the mount 4.

To retain the rod end 32 of the jack cylinder 30 within the boot cavity 110, the rod end 32 is positioned within an annular rim opening 131 defined by an annular rim 130 of the boot 100. As shown in FIGS. 3 and 4, a top end 120 of the boot 100 comprises a retaining ring 90 proximate a head 81 of the piston rod 80 and adjacent the annular rim 130. The retaining ring 90 includes an annular ledge 92 and a neck 93 that extends longitudinally along the longitudinal axis of the piston rod 80. The retaining ring 90 further includes a rod opening 91 operable to receive the head 81 of the piston rod 80. The rod opening 91 defines a clip recess 94 operable to receive at least a portion of a retaining clip 99. The retaining clip 99 is operable to secure the retaining ring 90 proximate the piston rod 80, specifically, to the head 81 of the piston rod 80 by preventing movement of the retaining ring 90 along the longitudinal axis of the piston rod 80. As shown, the head 81 of the piston rod 80 includes a groove 83 that is operable to receive at least a portion of the retaining clip 99. Due to the tight-fit of the retaining clip 99 positioned within the groove 83 and the clip recess 94, exposure to debris and/or fluids is reduced in the space between the head 81 and the rod opening 91. The retaining clip 99 may be an o-ring, washer, snap-ring, e-clip, spiral lock, or any component sufficient to retain the retaining ring 90 proximate the head 81 of the piston rod 80. The present disclosure also contemplates an alternative embodiment, where the retaining ring 90 may be integrally attached to the head 81 of the piston rod 80.

As shown in FIGS. 1, 3, and 4, the top end 120 of the boot 100 further comprises a first boot seal 160 and a second boot seal 170. In the illustrated embodiment, the first boot seal 160 serves as a sealing face for the boot 100. The first boot seal 160 is circular and defines a first rod opening 161 operable to receive the head 81 of the piston rod 80. The first boot seal 160 is positioned external to the boot 100 and includes a convex profile that substantially corresponds to the shape of the annular rim 130. The first boot seal 160 may be made of metal and extends along the annular rim 130 and downwards covering a portion of the top end 120 of the boot 100. The first boot seal 160 prevents debris and/or fluid from gaining access into the boot cavity 110. Similarly, the second boot seal 170 is circular and defines a second rod opening 171 operable to receive the head 81 of the piston rod 80. As shown in FIG. 4, the second boot seal 170 is positioned internal to the boot 100, within the boot cavity 110, and includes a convex profile that substantially corresponds to the shape of the annular rim 130. The second boot seal 170 may be a metal cap that distributes the spring force on the annular rim 130. The spring 40 contacts an inner surface 172 of the second boot seal 170 such that the spring force of the spring 40 biases the second boot seal 170 upwards along the longitudinal axis of the piston rod 80 against a bottom surface 132 of the annular rim 130. In turn, the annual rim 130 is biased against an inner surface 162 of the first boot seal 160 such that an outer surface 163 of the first boot seal 160 contacts a bottom surface 95 of the retaining ring 90. As discussed above, the retaining ring 90 is held in place on the head 81 of the piston rod 80 by the retaining clip 99 such that the spring 40 biases the second boot seal 170, the annular rim 130, and the first boot seal 160 against the bottom surface 95 of the retaining ring 90. This at least partially compresses the annular rim 130 between the second boot seal 170 and first boot seal 160 thereby sealing the top end 120 of the boot 100. This also ensures that exposure to debris and/or fluids is reduced in the space between the inner surface 162 of the first boot seal 160 and the corrugated surface 111, and/or, the space between the outer surface 163 of the first boot seal 160 and the bottom surface 95 of the retaining ring 90.

The present disclosure also contemplates an alternative embodiment (not shown) that does not include the second boot seal 170. In such an embodiment, the spring 40 contacts the bottom surface 132 of the annular rim 130 such that the spring force of the spring 40 biases the annular rim 130 upwards along the longitudinal axis of the piston rod 80 against the inner surface 162 of the first boot seal 160. In turn, the outer surface 163 of the first boot seal 160 contacts the bottom surface 95 of the retaining ring 90. As such, the spring 40 biases the annular rim 130 and the first boot seal 160 against the bottom surface 95 of the retaining ring 90. This at least partially compresses the annular rim 130 between the spring 40 and the first boot seal 160 thereby sealing the top end 120 of the boot 100. This also ensures that exposure to debris and/or fluids is reduced in the space between the inner surface 162 of the first boot seal 160 and the corrugated surface 111, and/or, the space between the outer surface 163 of the first boot seal 160 and the bottom surface 95 of the retaining ring 90.

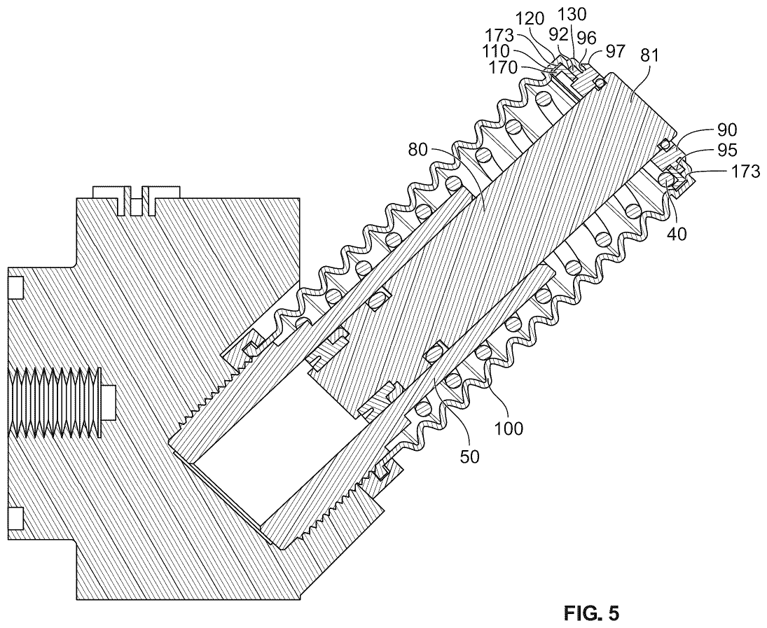

FIG. 5 depicts another alternative embodiment that does not include the first boot seal 160. As illustrated, the retaining ring 90 includes a rim cavity 96 disposed between the annular ledge 92 and an upper surface 97 of the retaining ring 90. The rim cavity 96 is operable to receive the annular rim 130 of the boot 100 in tight-fit engagement such that the top end 120 of the boot 100 is sealed. This also ensures that exposure to debris and/or fluids is reduced in the space between the rim cavity 96 and the annular rim 130. In the illustrated embodiment, the top end 120 of the boot 100 is shaped to correspond to the second boot seal 170 and the annular ledge 92 such that the inner surfaces of the boot cavity 110 contacts the outer surface 173 of the second boot seal 170 and the annular ledge 92 of the retaining ring 90. In this embodiment, the spring 40 biases the second boot seal 170 upwards along the longitudinal axis of the piston rod 80 against the bottom surface 95 of the retaining ring 90. The second boot seal 170 inhibits the spring 40 from extending beyond the second boot seal 170 towards the annular rim 130. In turn, the outer surface 173 of the second boot seal 170 contacts the bottom surface 95 of the retaining ring 90. This secures the retaining ring 90 to the head 81 of the piston rod 80 in conjunction with the retaining clip 99 that prevents movement along the longitudinal axis.

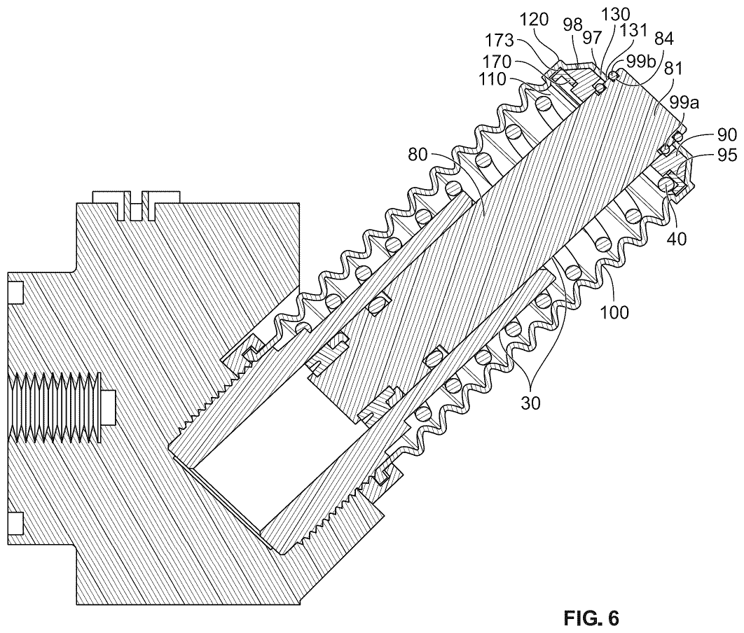

FIG. 6 depicts another alternative embodiment that does not include the rim cavity 96 or the first boot seal 160. As illustrated, the annular rim 130 is disposed proximate the upper surface 97 of the retaining ring 90. As shown, the head 81 of the piston rod 80 is closely received within the annular rim opening 131 of the boot 100. The diameter of the annular rim opening 131 relative to the diameter of the head 81 of the piston rod 80 is such that there is a tight interference fit between the annular rim opening 131 and head 81 of the piston rod 80. In the illustrated embodiment, a first retaining clip 99a, the retaining ring 90, the second boot seal 170, the spring 40, and at least a portion of the jack cylinder 30 are disposed within the boot cavity 110. As shown, the top end 120 of the boot 100 is shaped to correspond to the second boot seal 170 and the retaining ring 90 such that the inner surfaces of the boot cavity 110 contact the outer surface 173 of the second boot seal 170, a beveled edge 98 of the retaining ring 90, and the upper surface 97. In this embodiment, the spring 40 biases the second boot seal 170 against the bottom surface 95 of the retaining ring 90. The second boot seal 170 inhibits the spring 40 from extending beyond the second boot seal 170 towards the annular rim 130. A second retaining clip 99b disposed within a ring recess 84 on the head 81 of the piston rod 80 is operable to secure at least a portion of the annular rim 130 proximate the head 81 of the piston rod 80 by preventing movement of the second retaining clip 99b along the longitudinal axis of the piston rod 80. As such, the annular rim 130 is at least partially compressed between the second retaining clip 99b and the upper surface 97 of the retaining ring 90, thereby sealing the top end 120 of the boot 100. This also ensures that exposure to debris and/or fluids is reduced in the space between the second retaining clip 99b and the annular rim 130. The present disclosure contemplates that the second retaining clip 99b may be a washer, snap-ring, o-ring, e-clip, or spiral lock.

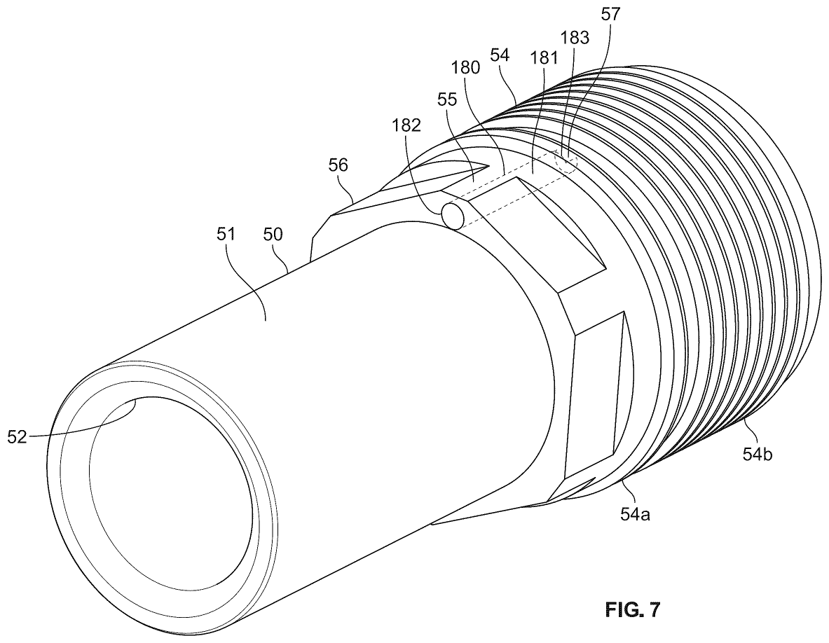

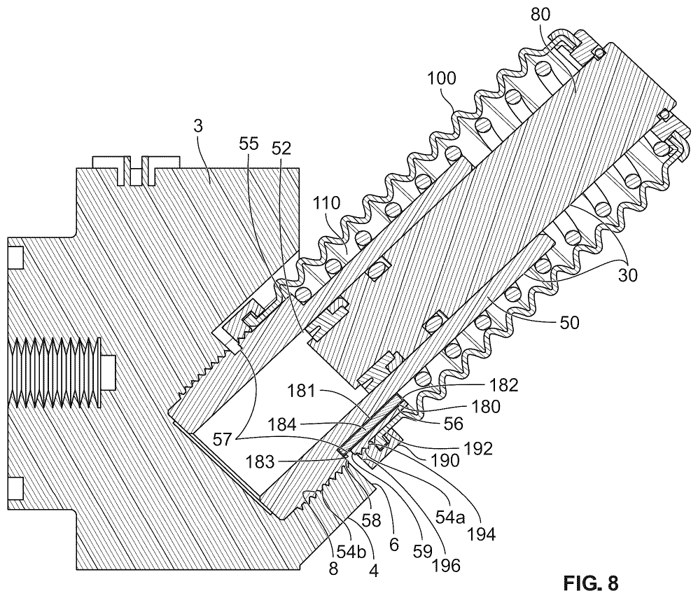

FIGS. 7-8 show an alternative embodiment of the jack cylinder 30. As illustrated, the barrel 50 of the jack cylinder 30 includes a port 180 for air exchange between the air in the boot cavity 110 and the atmosphere. The port 180 is operable to regulate negative and/or positive pressure within the boot cavity 110 as the boot 100 expands and collapses with the reciprocating piston rod 80 within the barrel 50. For example, as the boot 100 is collapsed with a down stroke of the piston rod 80, the port 180 regulates positive pressure within the boot cavity 110 by permitting air to flow from the boot cavity 110, through the port 180, and into the atmosphere. As the boot expands with an upstroke of the piston rod 80, the port 180 regulates negative pressure within the boot cavity 110 by permitting air to flow from the atmosphere, through the port 180, and into the boot cavity 110. In other words, the purpose of the port 180 is to prevent pressure build-up and/or suction within the boot cavity 110 as the piston rod 80 reciprocates within the barrel 50. As shown in FIGS. 7-8, the port 180 defines a hollow bore 181 that includes a cavity end 182 and a vent end 183. The port 180 is disposed along the longitudinal axis of the barrel 50 and through the body 51 of the barrel 50, specifically through at least a portion of the hex 56 and a portion of the second end 54. As shown in FIG. 7-8, the port 180 is disposed between an outer surface 55 of the barrel 50 and a bore 52 so as not to interfere with the fluid pressure in the bore 52 or a flange nut 190 threadably engaging with the second end 54.

As shown in FIGS. 7 and 8, the cavity end 182 of the port 180 is disposed through the hex 56 such that the cavity end 182 is open to the air in the boot cavity 110. The vent end 183 is disposed proximate an annular gap 57 such that the vent end 183 is open to the atmosphere. The annular gap 57 interrupts the threading on the second end 54 such that there are no threads between a first set of threads 54a and a second set of threads 54b. As shown in FIG. 8, the second set of threads 54b of the barrel 50, not the first set of threads 54a, threadably engages with the threaded inner surface 8 of the mount 4 such that the seat 6 is substantially co-planar with a first wall 58 of the annular gap 57. Conversely, the threaded inner surface portion 194 on the inner surface 192 of the flange nut 190 threadably engages with the first set of threads 54a, but not the second set of threads 54b, such that a bottom surface 196 of the flange nut 190 is substantially co-planar with a second wall 59 of the annular gap 57. As shown in FIG. 8, the flange nut 190 does not contact the seat 6 of the mount 4 or any portion of the jack base 3. Therefore, an air passage is defined by the walls 58,59 of the annular gap 57, the flange nut 190, and the jack base 3. Thus, the air passage is operable to permit airflow through the port 180. Specifically, air flows through the air passage and the vent end 183 such that the port 180 may regulate pressure within the boot cavity 110. In some embodiments, such as the illustrated embodiment in FIG. 8, a filter 184 may be disposed within the port 180 to reduce exposure to debris and/or fluids in the hollow bore 181 and ultimately, the boot cavity 110. The present disclosure contemplates that the filter 184 may be comprised of any material sufficient to prevent debris and/or fluids from entering the hollow bore 181, material such as felt, plastic (e.g., mesh), metal (e.g., mesh), or cloth.

The present disclosure also contemplates alternative embodiments including a plurality of ports to allow for sufficient air exchange between the boot cavity 110 and the atmosphere. It is also understood that the present disclosure contemplates that the port 180 may be included with any of the jack cylinders and the boots described herein and is therefore not limited to being disposed through the barrel 50 shown in FIGS. 7-8. Indeed, the port 180 may be disposed within the barrels shown in any of the figures. In some embodiments, the port 180 may be disposed through the retaining ring 90 such that there is sufficient air exchange between the boot cavity and the atmosphere. In this embodiment, the bottom surface 196 of the flange nut 190 still contacts the seat 6 of the mount 4 as shown in FIG. 4. Accordingly, the port 180 may be disposed anywhere on the ingress prevention system 1 that allows for sufficient air exchange between the boot cavity 110 and the atmosphere.

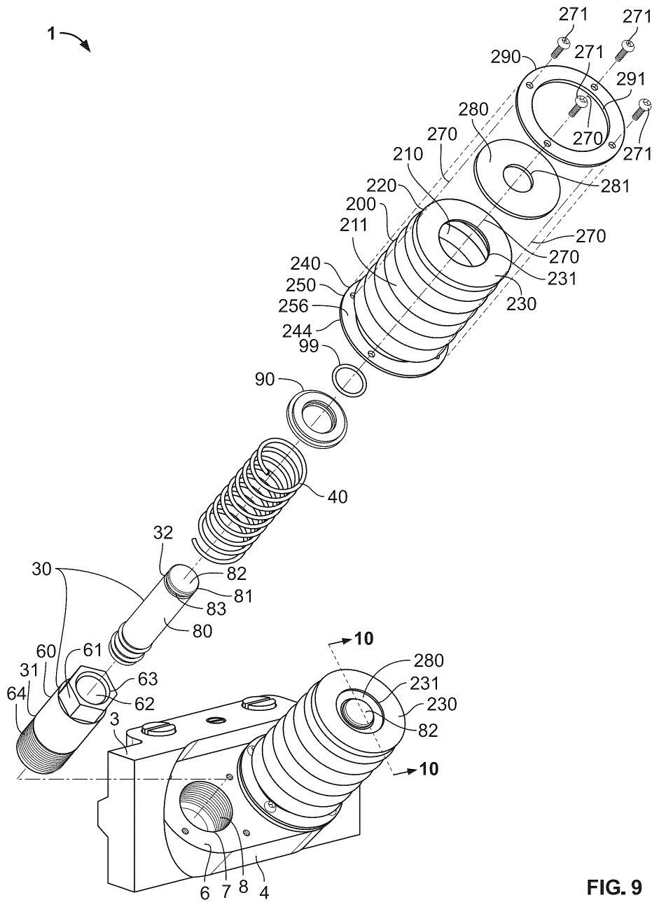

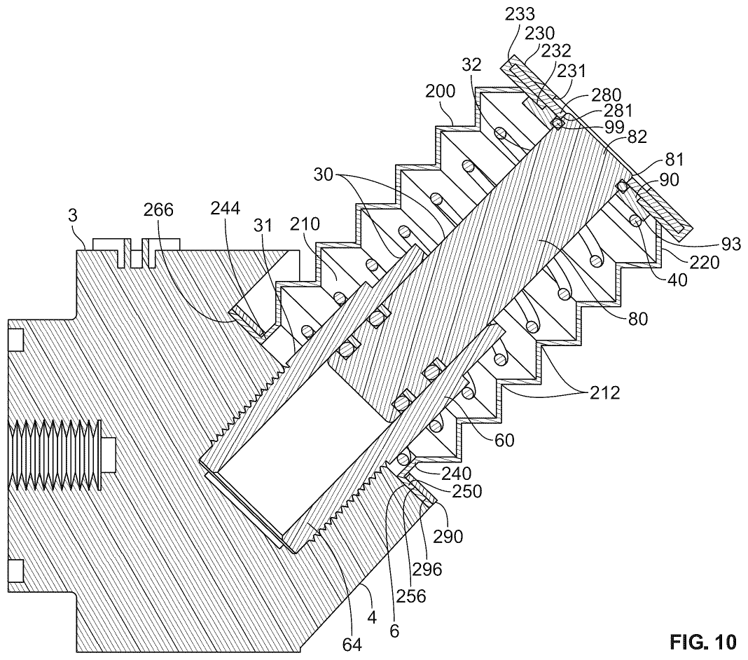

FIGS. 9-10 show an alternative embodiment of the ingress prevention system 1. As illustrated, the system comprises a boot 200 operable to receive the jack cylinder 30 within a boot cavity 210. In the illustrated embodiment, the boot 200 includes a top end 220 and a bottom end 240, each of which are operable to retain the rod end 32 and barrel end 31 (respectively) of the jack cylinder 30 within the boot cavity 210. The top end 220 of the boot 200 includes an annular rim 230 that defines an annular rim opening 231 and a plate cavity 233 disposed within the annular rim 230. As shown in FIGS. 9-10, the boot 200 further comprises a plate 280 with at least one plate opening 281 operable to receive the exposed end 82 of the piston rod 80. The plate cavity 233 of the annular rim 230 is operable to receive at least a portion of the plate 280 to retain at least a portion of the rod end 32 of the jack cylinder 30 within the boot cavity 210. The plate 280 is shaped to correspond to the shape of the annular rim 230. The present disclosure contemplates that the plate 280 may be comprised of any shape sufficient to retain at least a portion of the rod end 32 of the jack cylinder 30 within the boot cavity 210. The top end 220 of the boot 200 further includes the retaining ring 90 and the first retaining clip 99 operable to retain the retaining ring 90 proximate the head 81 of the piston rod 80 by preventing movement along the longitudinal axis of the piston rod 80. The bottom end 240 includes a barrel opening 244 and an annular lip 250 that defines a planar surface 256. Like the boot 100 shown in FIGS. 1-3, boot 200 is flexible, and includes a corrugated surface 211 with a plurality of folds 212 that allow the boot 200 to expand and collapse as the piston rod 80 reciprocates within a bore 62 of a barrel 60. In the preferred embodiment, the bottom end 240 of the boot 200 is secured to the jack base 3 by a flange 290. In the illustrated embodiment, the flange 290 is disposed around at least a portion of the boot 200 near the bottom end 240 and is positioned adjacent the annular lip 250, specifically on the planar surface 256 of the boot 200. Like the illustrated embodiment shown in FIGS. 1-4, a second end 64 of the barrel 60 threadably engages the threaded inner surface 8 of the barrel opening 7 of the mount 4 to secure the barrel 60 to the jack base 3. As shown in FIGS. 9-10, the first end 63 defines a first end nut 61 operable to receive at least a portion of the piston rod 80 and engage with a tool (not shown) for threading the barrel 60 into the barrel opening 7. The first end nut 61 may be a hex-type nut or another type of drive nut geometry.

To retain the barrel end 31 of the jack cylinder 30 within the boot cavity 210, the second end 64 of the barrel 60 is positioned within the barrel opening 244 of the bottom end 240 of the boot 200. The bottom end 240 of the boot 200 is secured to the mount 4 by the flange 290. In the illustrated embodiment, the flange 290 is circular and includes a cylinder opening 291 operable to receive at least a portion of the boot 200. The flange 290 also includes a bottom surface 296 that mates with the planar surface 256 of the annular lip 250 to secure the annular lip 250 to the jack base 3. For example, the flange 290 is positioned proximate the annular lip 250 by bringing the bottom surface 296 in contact with the planar surface 256 of the annular lip 250. In some embodiments, the flange 290, the annular lip 250, and the jack base 3 include through-openings 270 operable to receive fasteners 271. In these embodiments, the fasteners 271 are operable to secure the flange 290 and the annular lip 250 to the mount 4 of the jack base 3. Securing the annular lip 250 to the mount 4 via the flange 290 brings a bottom surface 266 of the annular lip 250 in contact with the seat 6 of the mount 4. This ensures that exposure to debris and/or fluids is reduced in the space between the seat 6 of the mount 4 and the annular lip 250 of the boot 200.

To retain the rod end 32 of the jack cylinder 30 within the boot cavity 210, the rod end 32 of the jack cylinder 30 is positioned proximate the annular rim opening 231 of the top end 220 of the boot 200. As shown in FIGS. 9-10, at least a portion of the rod end 32 of the jack cylinder 30 is retained within the boot cavity 210 by positioning the rod end 32 within the annular rim opening 231 of the boot 200 and the plate opening 281 of the plate 280. The plate opening 281 is operable to receive the head 81 of the piston rod 80 such that the exposed end 82 protrudes beyond the plane of the plate 280. Accordingly, to reduce exposure to debris and/or fluids near the rod end 32 of the jack cylinder 30, the plate 280 is disposed within the plate cavity 233 of the annular rim 230. Due to the interference fit of the head 81 of the piston rod 80 positioned within the opening 281 of the plate 280, exposure to debris and/or fluids is reduced in the space between the head 81 and the opening 281. Further, securing the annular lip 250 to the seat 6 of the mount 4 via the flange 290 brings the bottom surface 232 of the annular rim 230 in contact with the retaining ring 90. In the same or similar manner as discussed above with respect to boot 100, the spring 40 contacts the retaining ring 90 such that the spring force of the spring 40 biases the retaining ring 90 upwards along the longitudinal axis of the piston rod 80 against the bottom surface 232 of the annular rim 230 and the plate 280. This maintains the contact between the retaining ring 90 and the plate 280 and ensures that debris and/or fluids may not penetrate the space between the plate 280 and the annular rim opening 231 of the annular rim 230.

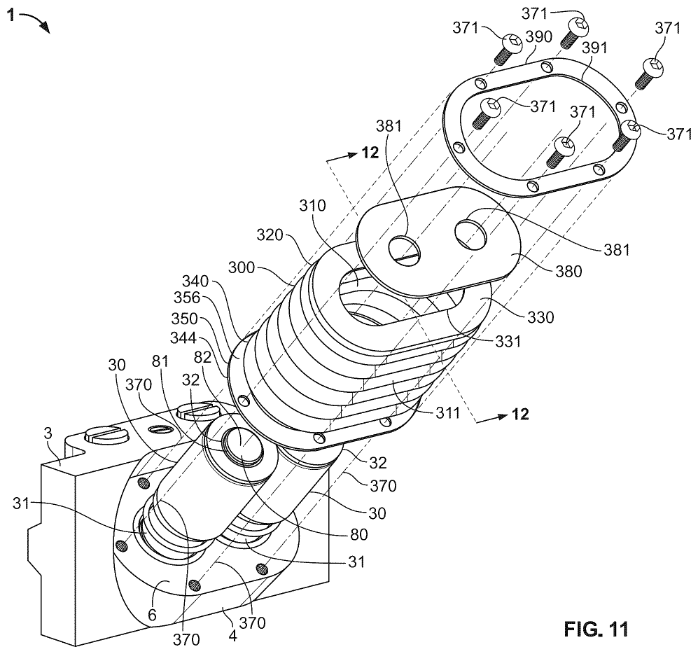

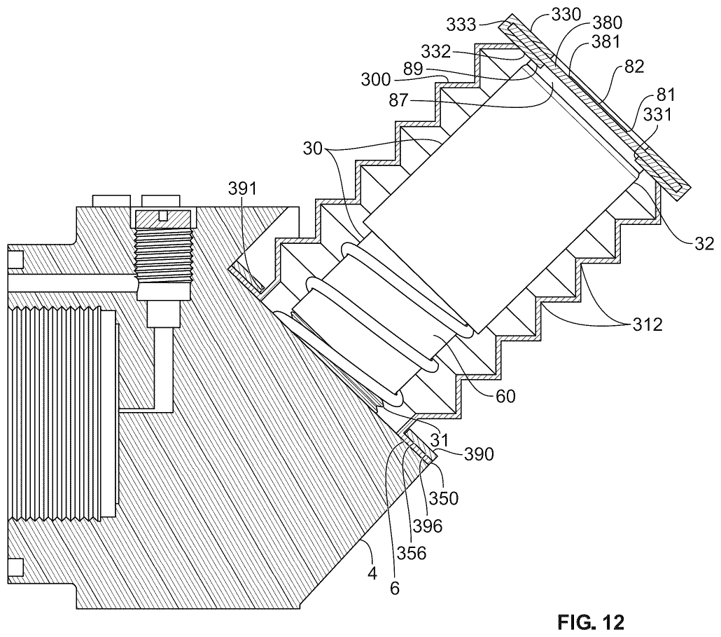

In an alternative embodiment, the rod end 32 of the jack cylinder 30 includes a piston rod cap 87 secured to a head 81 of the piston rod 80. In some embodiments, the piston rod cap 87 is integrally attached to the head 81 of the piston rod 80. The piston rod cap 87 covers at least a portion of the spring 40, the barrel 60, and the piston rod 80. In another embodiment, the piston rod cap 87 includes a shield 88 integrally attached to the retaining ring 90, and further includes the first retaining clip 99 operable to retain the retaining ring 90 proximate the head 81 of the piston rod 80 by preventing movement along the longitudinal axis of the piston rod 80 (See e.g., FIGS. 11-12). In this embodiment, the diameter of the annular rim opening 231 of the annular rim 230 is sized smaller than the diameter of the retaining ring 90 of the piston rod cap 87. This retains the rod end 32 of the jack cylinder 30 within the boot cavity 210, as the retaining ring 90 is unable to protrude through the annular rim opening 231. Further, retaining the barrel end 31 within the boot cavity 210 via the flange 290 brings a bottom surface 232 of the annular rim 230 in contact with a top surface 89 of the piston rod cap 87. This ensures that exposure to debris and/or fluids is reduced in the space between the annular rim 230 of the boot 200 and the top surface 89 of the piston rod cap 87. As the rollers 11 actuate the jack cylinders 30 at the rod ends 32, the rollers 11 engage with the head 81 of the piston rod 80 and at least a portion of the annular rim 230. This engagement maintains the contact between the bottom surface 232 of the annular rim 230 and the top surface 89 of the piston rod cap 87 as the piston rod 80 reciprocates within the barrel 60.

In an alternate embodiment shown in FIGS. 11-12, the ingress prevention system 1 comprises a boot 300 operable to receive a plurality of jack cylinders 30 within a boot cavity 310. In the illustrated embodiment, the boot 300 includes a top end 320 and bottom end 340, each of which are operable to retain the rod ends 32 and barrel ends 31 (respectively) of the plurality of jack cylinders 30 within the boot cavity 310. The top end 320 of the boot 300 includes an annular rim 330 that defines an annular rim opening 331 and a plate cavity 333 disposed within the annular rim 330. The bottom end 340 includes a barrel opening 344 and an annular lip 350 that defines a planar surface 356. As shown in FIGS. 11-12, the boot 300 further comprises a plate 380 with a plurality of openings 381 operable to receive the exposed ends 82 of the piston rods 80. The plate cavity 333 of the annular rim 330 is operable to receive at least a portion of the plate 380 to retain at least a portion of the rod ends 32 of the jack cylinders 30 within the boot cavity 310. The plate 380 is shaped to correspond to the shape of the annular rim 330 and includes at least one plate opening 381. The present disclosure contemplates that the plate 380 may be comprised of any shape sufficient to retain at least a portion of the rod ends 32 of the plurality of jack cylinders 30 within the boot cavity 310.

Like boots 100, 200, boot 300 shown in FIGS. 11-12 is flexible, and includes a corrugated surface 311 with a plurality of folds 312 that allow the boot 300 to expand and collapse as the piston rod 80 reciprocates within the bore 62 of the barrel 60 (as shown in FIGS. 9-10). In the illustrated embodiment, a flange 390 is disposed around at least a portion of the boot 300 and is positioned adjacent the annular lip 350, specifically on the planar surface 356 of the boot 300. The flange 390, the annular lip 350, and the seat 6 includes through-openings 370 operable to receive a plurality of fasteners 371 for securing the flange 390 and the annular lip 350 to the mount 4 of the jack base 3. As shown, the flange 390 is oblong and includes a cylinder opening 391 operable to receive at least a portion of the boot 300 and the jack cylinders 30. The flange 390 also includes a bottom surface 396 that mates with the planar surface 356 of the annular lip 350. Similar to flange 290, flange 390 secures the annular lip 350 to the jack base 3 by bringing the bottom surface 396 of the annular lip 350 in contact with the seat 6 of the mount 4. This ensures that exposure to debris and/or fluids is reduced in the space between the seat 6 of the mount 4 and the annular lip 350 of the boot 300.

As shown in FIGS. 11-12, the barrel ends 31 of the plurality of jack cylinders 30 are retained within the boot cavity 310 in the same or similar manner as described above with respect to boot 200 and flange 290 (as shown in FIGS. 9-10). In some embodiments, the rod ends 32 of the jack cylinders 30 are retained within the boot cavity 310 in the same or similar manner as described above with respect to boot 200 where a bottom surface 332 of the annular rim 330 contacts the top surface 89 of the piston rod cap 87, or the retaining ring 90 (as shown in FIGS. 9-10). In the illustrated embodiment, at least a portion of the rod ends 32 of the plurality of jack cylinders 30 are retained within the boot cavity 310 by positioning the rod ends 32 within the annular rim opening 331 of the boot 300 and the plate openings 381 of the plate 380. As shown, the plate openings 381 are operable to receive each of the heads 81 of the piston rods 80 such that the exposed ends 82 protrude beyond the plane of the plate 380. Accordingly, to reduce exposure to debris and/or fluids near the rod ends 32 of the jack cylinders 30, the plate 380 is disposed within the plate cavity 333 of the annular rim 330. Due to the interference fit of the heads 81 of the piston rods 80 positioned within the openings 381 of the plate 380, exposure to debris and/or fluids is reduced in the space between the heads 81 and the openings 381. Further, securing the annular lip 350 to the seat 6 of the mount 4 via the flange 390 brings the plate 380 in contact with the top surfaces 89 of the piston rod caps 87. This ensures that debris and/or fluids may not penetrate the space between the plate 380 and the annular rim opening 331 of the annular rim 330. Because the heads 81 of the piston rods 80 are positioned within each of the openings 381 of the plate 380, and the plate 380 is in contact with the top surfaces 89 of both piston rod caps 87 (as shown in FIG. 12), the plate 380 also assists in evenly distributing the load between the plurality of jack cylinders 30 as the rollers 11 engage the jack cylinders 30.

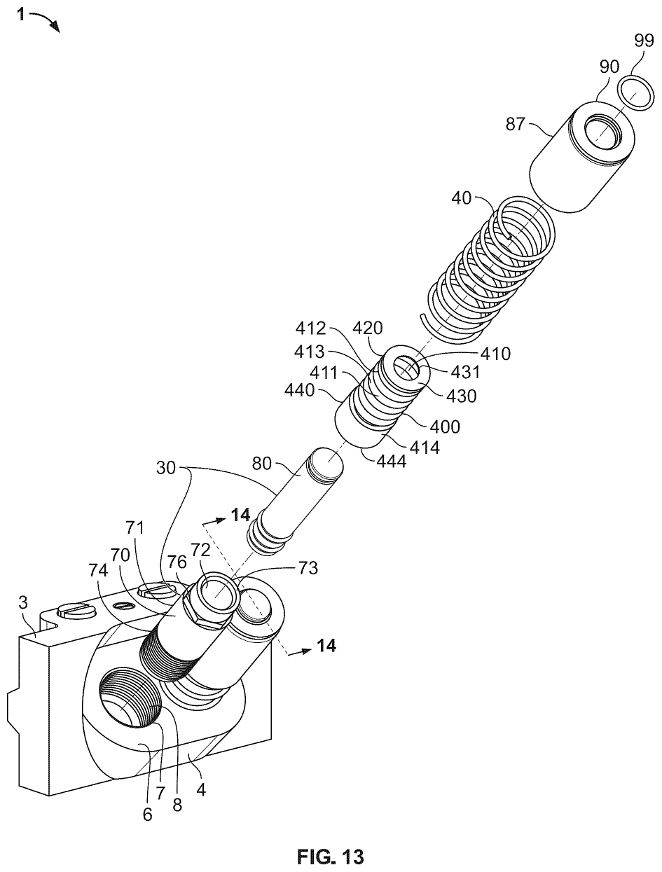

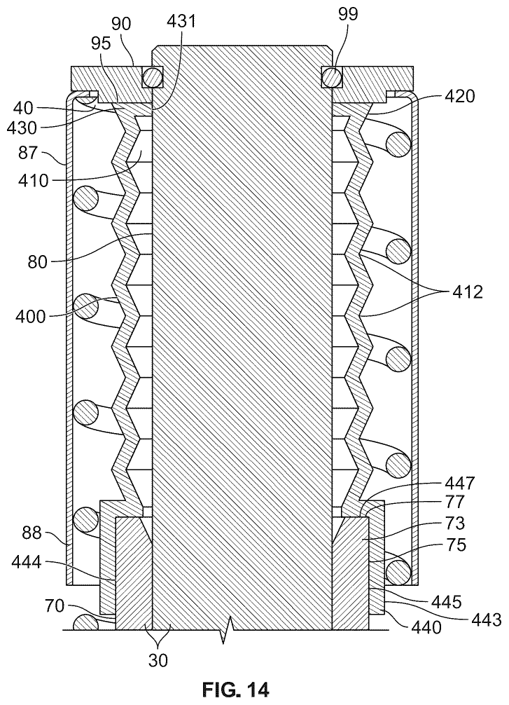

In an alternate embodiment shown in FIGS. 13-14, the ingress prevention system 1 comprises a boot 400 operable to receive at least a portion of the jack cylinder 30 within a boot cavity 410. In the illustrated embodiment, the boot 400 is positioned immediately proximate the piston rod 80 with portions of the spring 40 surrounding the boot 400 and the piston rod cap 87 surrounding the spring 40. The boot 400 includes a top end 420 operable to retain at least a portion of the piston rod 80 within the boot cavity 410 and bottom end 440 operable to retain at least a portion of a barrel 70 within the boot cavity 410. The top end 420 of the boot 400 includes an annular rim 430 that defines an annular rim opening 431 operable to receive at least a portion of the piston rod 80. The bottom end 440 includes a barrel opening 444 operable to at least partially receive the barrel 70. Additionally, the boot 400 further includes a flexible portion 413, the flexible portion 413 defining a corrugated surface 411 with a plurality of folds 412 that allow the boot 400 to expand and collapse as the piston rod 80 reciprocates within a bore 72 of the barrel 70. The boot 400 also includes a stiff portion 414 that remains static. In the illustrated embodiment, the barrel 70 includes a body 71 that defines a nut 76. The nut 76 is disposed between a first end 73 and a second end 74, proximate the first end 73. The nut 61 may be a hex-type nut or another type of drive nut geometry. Like barrel 50 and barrel 60, the second end 74 of the barrel 70 threadably engages the threaded inner surface 8 of the barrel opening 8 of the mount 4 to secure the barrel 70 to the jack base 3.

To retain at least a portion of the barrel 70 and the piston rod 80 within the boot cavity 410, the first end 73 of the barrel 70 is positioned within the barrel opening 444 of the bottom end 440 of the boot 400. The diameter of the barrel opening 444 relative to the diameter of the barrel 70 is such that there is a tight interference fit between the barrel opening 444 and the first end 73 of the barrel 70. As shown in FIG. 14, the bottom end 440 of the boot 400 includes an outer surface 443, an inner surface 445 for contacting an outer surface 75 of the barrel 70, and a stop 447 for contacting a top surface 77 of the barrel 70. The interference fit and the contact between the bottom end 440 of the boot 400 and the barrel 70 ensures that exposure to debris and/or fluid is reduced in the space between the inner surface 445 of the bottom end 400 and the outer surface 75 of the barrel 70. In other embodiments, the ingress prevention system 1 further comprises a clamp (not shown) disposed around the outer surface 443 of the bottom end 440 of the boot 400, the clamp operable to secure the bottom end 440 of the boot 400 to the first end 73 of the barrel 70. The present disclosure contemplates that the clamp may be any type of clamp or component sufficient to secure the bottom end 440 of the boot 400 to the first end 73 of the barrel 70.

As shown in FIG. 14, a portion of the piston rod 80 is positioned within the annular rim opening 431 of the top end 420 of the boot 400. The annular rim 430 contacts the bottom surface 95 of the retaining ring 90 to ensure that exposure to debris and/or fluids is reduced in the space between the annular rim 430 and the bottom surface 95 of the retaining ring 90. For example, as the piston rod 80 reciprocates within the barrel 70, the annular rim 430 is biased against the bottom surface 95 of the retaining ring 90. This maintains the contact between the annular rim 430 and the bottom surface 95 of the retaining ring 90. As such, boot 400 reduces exposure to debris and/or fluids even where the length of the shield 88 of the piston rod cap 87 does not extend to fully cover the entire length of the jack cylinder 30. In alternative embodiments, the piston rod cap 87 may extend varying lengths covering the jack cylinder 30 or the piston rod cap 87 may not cover any portion of the jack cylinder 30.

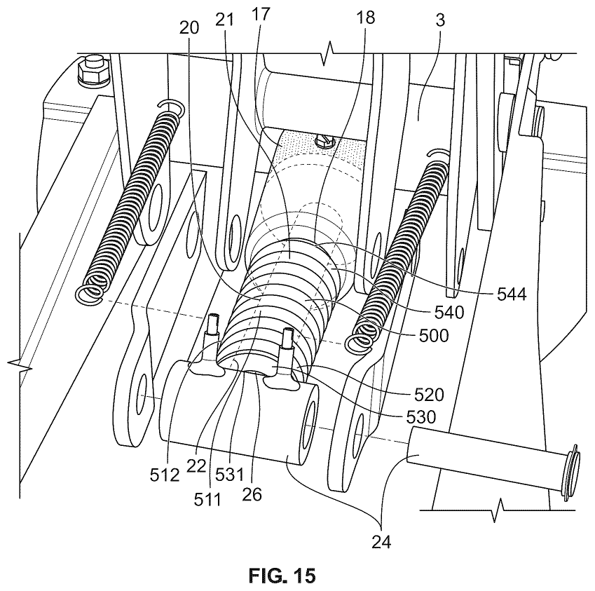

The present disclosure contemplates that the debris and/or prevention system 1 is not limited for use with the jack cylinders 30 actuated by the handle 10 as shown in FIGS. 1-14, but may be used with other pneumatic or hydraulic cylinders. For example, in the embodiment shown in FIG. 15, the piston rod is the ram 20 and the barrel is the fluid reservoir 17. In this embodiment, the fluid reservoir 17 includes a housing end (not shown) secured to the jack base 3 and a ram end 18 that defines a nut operable to receive the ram 20. The ram 20 includes a shaft 21 and a pushing end 22 which is coupled to the second lever pivot 24 at a joint 26. As shown in FIG. 15, the ingress prevention system 1 comprises a boot 500 operable to receive at least a portion of the ram 20 and the fluid reservoir 17 within the boot 500. In the illustrated embodiment, the boot 500 includes a top end 520 and bottom end 540, each of which are operable to retain at least a portion of the ram end 18 and the joint 26 (respectively) within the boot 500. The top end 520 of the boot 500 includes an annular rim 530 that defines a ram opening 531. In some embodiments, the bottom end 540 includes a barrel opening 544 and an annular lip that defines a planar surface. Boot 500 is flexible, and includes a corrugated surface 511 with a plurality of folds 512 that allow the boot 500 to expand and collapse as the ram 20 reciprocates within the fluid reservoir 17.

To retain the portion of the ram 20 proximate the fluid reservoir 17 within the boot 500, a portion of the ram 20 and the ram end 18 of the fluid reservoir 17 are positioned within the barrel opening 544 of the bottom end 540. In some embodiments, a bottom surface of the annular lip is shaped to substantially conform to the ram end 18 of the fluid reservoir 17. The bottom surface therefore contacts the ram end 18 of the fluid reservoir 17 to ensure that exposure to debris and/or fluids is reduced in the space between the bottom surface and the ram end 18 of the fluid reservoir 17. As the ram 20 reciprocates within the fluid reservoir 17, the bottom surface of the annular lip is biased against the ram end 18 which maintains the contact between the bottom surface of the boot 500 and the ram end 18. In other embodiments, the ram end 18 of the fluid reservoir 17 is retained within the boot 500 in the same or similar manner as described above with respect to retaining the barrel end 31 within the boot cavities of boots 100, 200, 300, or 400. To retain the portion of the ram 20 proximate the pivot 24 within the boot 500, a portion of the ram 20 is positioned within the ram opening 531 of the boot 500. In some embodiments, the annular rim 530 is shaped to substantially conform to the surfaces of the pivot 24. The annular rim 530 therefore contacts the pivot 24 to ensure that exposure to debris and/or fluids is reduced in the space between the annular rim 530 and the pivot 24. As the ram 20 reciprocates within the fluid reservoir 17, the annular rim 530 is biased against the pivot 24 which maintains the contact between the annular rim 530 and surfaces of the pivot 24. In other embodiments, the pushing end 22 of the ram 20 is retained within the boot 500 in the same or similar manner as described above with respect to retaining the rod end 32 within the boot cavities of boots 100, 200, 300, or 400. The present disclosure contemplates that boots 100, 200, 300, or 400 are operable to retain at least one ram 20 and fluid reservoir 17 within the respective boot cavities.

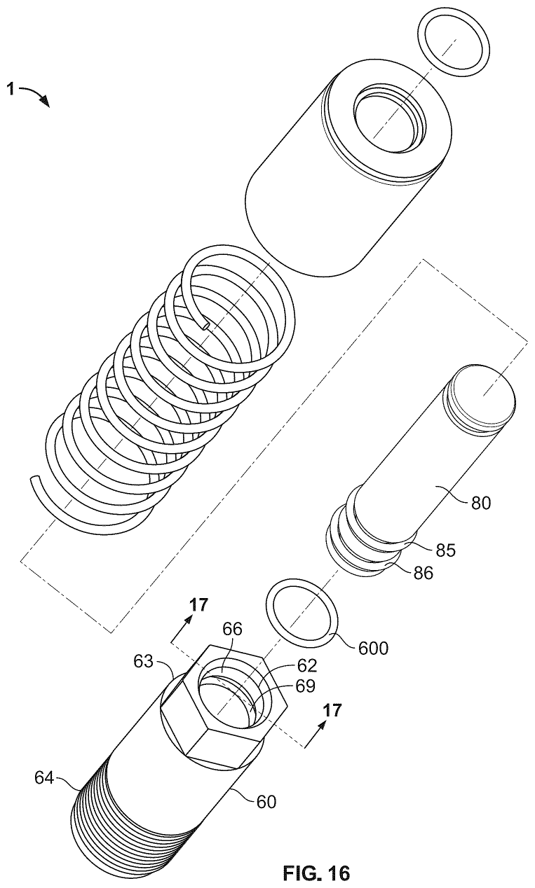

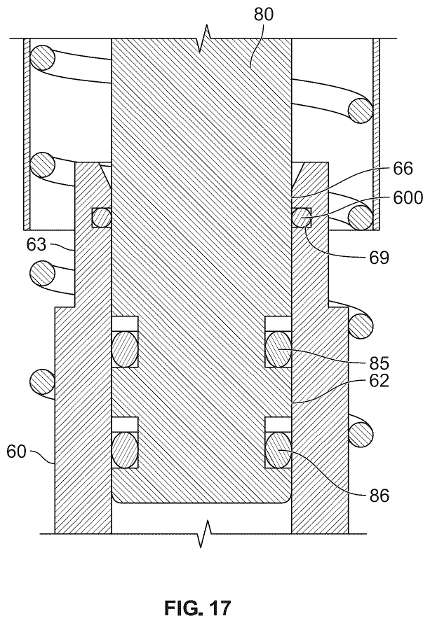

The present disclosure contemplates an ingress prevention system 1 that further comprises a barrel seal secured to the barrel (e.g., 50, 60, or 70) of the jack cylinder 30 or fluid reservoir 17. It is also to be understood that the present disclosure contemplates that the ingress prevention system 1 may comprise the foregoing boots 100, 200, 300, 400, or 500, and optionally the barrel seal, or, the barrel seal without the boots. In any of these embodiments, the ingress prevention system 1 is operable to substantially reduce exposure to debris and/or fluids. For example, a barrel seal 600 shown in FIGS. 16 and 17 is disposed within the bore 62 of the barrel 60 and specifically within a groove 69 disposed on an inner surface 66 of the barrel 60. The diameter of the barrel seal 600 relative to the diameter of the piston rod 80 is such that there is a tight interference fit between the barrel seal 600 and the piston rod 80. As such, the barrel seal 600 is operable to wipe or clear debris and/or fluid from the surfaces of the piston rod 80 as the piston rod 80 reciprocates in the barrel 60. The groove 69 is advantageously disposed proximate the first end 63 of the barrel 60, permitting the barrel seal 600 to wipe the surfaces of the piston rod 80 before any debris and/or fluid from the external environment compromises the rod seal 85, the piston seal 86, or the surfaces of the piston rod 80 or the bore 62. As shown in FIGS. 16 and 17, the barrel seal 600 is an o-ring, but may also be any type of seal, guide ring, wiper, and/or scraper sufficient to wipe or clear debris/or fluids from the piston rod 80.

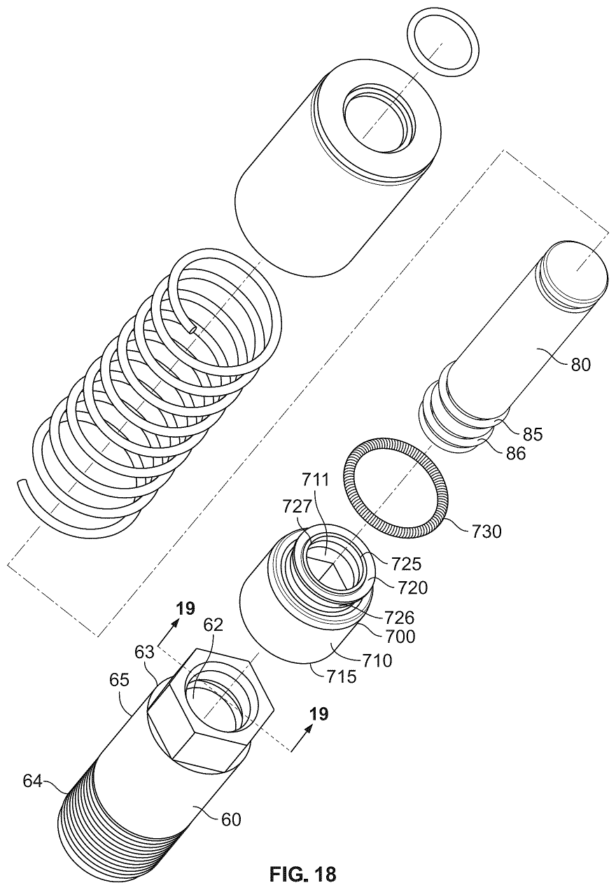

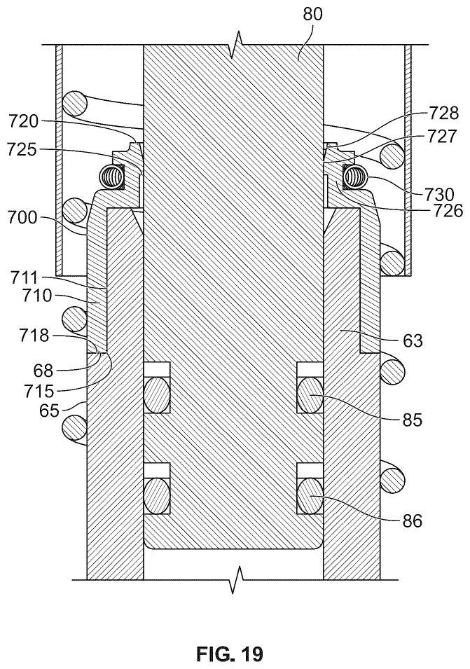

In the embodiment shown in FIGS. 18-19, a barrel seal 700 includes a wiper 720 mounted on and/or integrally attached to a coupling 710, and a spring 730 disposed around a neck 726 of the wiper 720 that extends upwards along the longitudinal axis of the piston rod 80. The coupling 710 defines a barrel opening 715 operable to receive the first end 63 of the barrel 60 and the wiper 720 defines a rod opening 725 operable to receive at least a portion of the piston rod 80. The barrel seal 700 is advantageously disposed proximate the first end 63 of the barrel 60, permitting the barrel seal 700 to wipe the surfaces of the piston rod 80 before any debris and/or fluid from the external environment compromises the rod seal 85, the piston seal 86, the surfaces of the piston rod 80, or the bore 62.

To wipe or clear debris and/or fluid from piston rod 80 as the piston rod 80 reciprocates within the barrel 60, the coupling 710 is secured to the first end 63 of the barrel 60 and the piston rod 80 is positioned within the rod opening 725 of the wiper 720. In some embodiments, the inner surface 711 of the coupling 710 is shaped to correspond with the shape of the first end 63 of the barrel 60 such that there is a tight interference fit between the inner surface 711 and the first end 63 of the barrel 60. In the illustrated embodiment, the inner surface 711 and at least a portion of the first end 63 of the barrel 60 is hexagonal. In alternative embodiments, a portion of the first end 63 of the barrel 60 may be cylindrical and operably couple to a coupling 710 (e.g., a valve stem seal) with a cylindrical inner surface 711 or bore, see FIG. 13. As shown in FIG. 19, a bottom surface 718 of the coupling 710 contacts a seat 68 on the first end 63 of the barrel 60. This ensures that exposure to debris and/or fluids is reduced in the space between the outer surface 65 of the barrel 60 and the barrel opening 715 of the coupling 710. With respect to the wiper 720, the diameter of the rod opening 725 of the wiper 720 relative to the diameter of the piston rod 80 is such that there is a tight interference fit between the rod opening 725 of the wiper 720 and the piston rod 80. In the illustrated embodiment, the wiper 720 includes a lip 727 that defines a frustoconical surface 728. At least a portion of the lip 727 contacts the surfaces of the piston rod 80. Because of the contact, the wiper 720 is operable to wipe or clear debris and/or fluid from the surfaces of the piston rod 80 as the piston rod 80 reciprocates in the barrel 60. This also ensures that exposure to debris and/or fluids is reduced in the space between the lip 727 and the surfaces of the piston rod 80. Furthermore, compression of the spring 730 disposed around the neck 726 of the wiper 720 maintains the contact between the lip 727 of the wiper 720 and the piston rod 80 to ensure that debris and/or fluids may not penetrate the bore 62. In some embodiments, barrel seal 700 is used in conjunction with barrel seal 600. In other embodiments, barrel seal 700 is used without barrel seal 600 such that either barrel seal 600 or barrel seal 700 are optional in the ingress prevention system 1. The present disclosure contemplates that barrel seals 600,700 may be comprised of any suitable material sufficient to wipe or clear debris and/or fluids from the surfaces of the piston rod 80, material such as nylon, polytetrafluoroethylene, rubber, and/or steel.

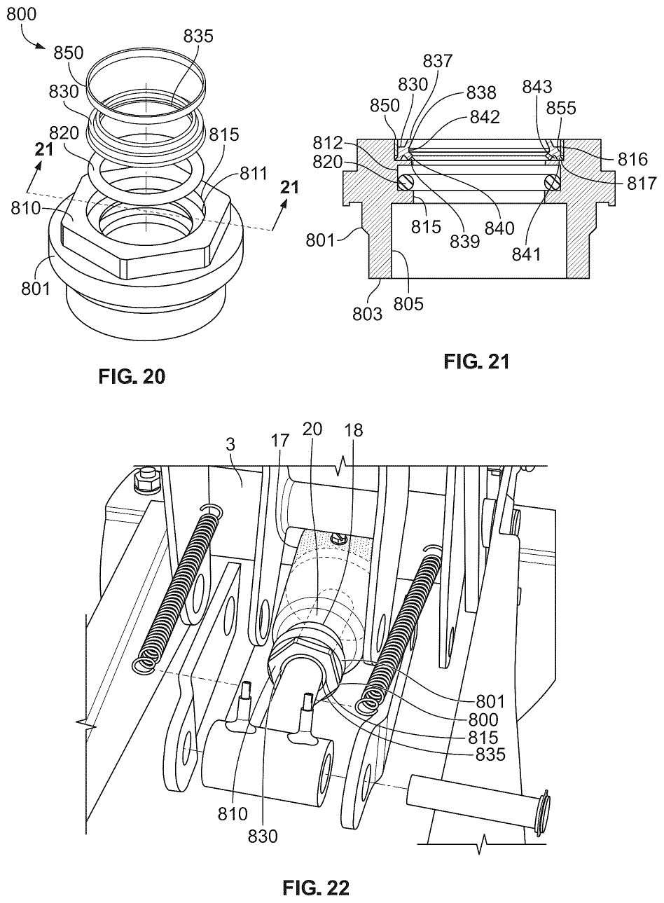

The present disclosure contemplates that the ingress prevention system 1 further comprises a ram seal 800 secured to the ram end 18 of the fluid reservoir 17. It is also to be understood that the present disclosure contemplates that the ingress prevention system 1 may comprise the foregoing boots 100, 200, 300, 400, or 500, and optionally the ram seal 800, or, the ram seal 800 without the boots. In any of these embodiments, the ingress prevention system 1 is operable to substantially reduce exposure to debris and/or fluids. For example, as shown in FIGS. 20-22, the ram seal 800 includes a ram nut 810 integrally attached to a body 801. In the illustrated embodiment, the ram nut 810 is hexagonal. The ram nut 810 defines a ram opening 815 operable to receive the ram 20 and at least a portion of the fluid reservoir 17. As shown in FIGS. 20-21, the ram opening 815 includes a reservoir opening 805 operable to receive the ram end 18 of the fluid reservoir 17. The ram opening 815 further includes a seal cavity 812 operable to receive a rod seal 820 for leak prevention and wiping debris from the ram 20. The ram opening 815 further includes a wiper recess 811 operable to receive a retaining ring 850 and a wiper 830. As shown, the retaining ring 850 is disposed within the wiper recess 811 by contacting an inner wall 816. The wiper 830 is disposed within an inner surface 855 of the retaining ring 850. Like the ram nut 810, the wiper 830 defines a ram opening 835 that coincides with the ram opening 815 of the ram nut 810 such that the ram nut 810 and wiper 830 are both operable to receive the ram 20 within the ram openings 815, 835. As shown in FIG. 22, the ram seal 800 is advantageously disposed proximate the ram end 18 of the fluid reservoir 17, permitting the ram seal 800 to wipe the surfaces of the ram 20 before any debris and/or fluid from the external environment compromises the fluid, seals, or structures within the fluid reservoir 17.

To wipe or clear debris and/or fluid from the surfaces of the ram 20 as the ram 20 reciprocates within the fluid reservoir 17, the body 801 is secured to the ram end 18 of the fluid reservoir 17 and the ram 20 is positioned within the ram openings 815,835 of the ram nut 810 and the wiper 830, respectively. In one embodiment, the diameter of the reservoir opening 805 of the body 801 relative to the diameter of the ram end 18 is such that there is a tight interference fit between the reservoir opening 805 and the ram end 18 of the reservoir. In another embodiment, an inner surface of the reservoir opening 805 is threaded and threadably engages a threaded neck (not shown) disposed on the ram end 18 of the fluid reservoir 17. In either embodiment, securing the body 801 to the ram end 18 ensures that exposure to debris and/or fluids is reduced in the space between a bottom surface 803 of the body 801 and the ram end 18 of the fluid reservoir 17. Similarly, the diameter of the ram opening 835 of the wiper 830 relative to the diameter of the ram 20 is such that there is a tight interference fit between the ram opening 835 of the wiper 830 and the ram 20. In the illustrated embodiment, the wiper 830 includes a first lip 837 having a first contact surface 838 and a second lip 839 having a second contact surface 840. As shown in FIG. 21, the first lip 837 extends upwards along the longitudinal axis of the body 801. The first and second lips 837, 839 define a concavity 842 between the first contact surface 838 and second contact surface 840. Wiper 830 also includes an annular cavity 843 disposed proximate a bottom surface 841 that contacts the annular seat 817 of the wiper recess 811. The first and second contact surfaces 838, 840 contact the surfaces of the ram 20 to ensure that debris and/or fluids may not penetrate the space between the first lip 837 and the surfaces of the ram 20. In other embodiments, the second lip 839 assists to retain fluid within the fluid reservoir 17 as the ram 20 reciprocates within the fluid reservoir 17. As such, the wiper 830 is operable to wipe or clear debris and/or fluid from the surfaces of the ram 20 as the ram 20 reciprocates in the fluid reservoir 17. The present disclosure contemplates that the wiper 830 may be comprised of any shape sufficient to wipe or clear debris and/or fluids from the surfaces of the ram 20. For example, in some embodiments, the wiper 830 includes an extended lip or a single lip.

The present described disclosure is described in such full, clear, concise, and exact terms as to enable any person skilled in the art to which it pertains to practice the same. It is to be understood that the foregoing described preferred aspects of the disclosure and that modification may be made therein without departing from the spirit of scope of the disclosure as set forth in the appended claims. The scope of the following claims is to be accorded the broadest interpretation to encompass all such modifications and equivalent structures and functions. Therefore, it is intended that the application not be limited to the particular aspects disclosed, but that the application will include all aspects falling within the scope of the appended claims.

What is claimed is:

1. An ingress prevention system for use with pneumatic or hydraulic jacks, comprising:
a jack cylinder including a piston rod, a barrel, and a piston rod cap, wherein the barrel is operable to receive at least a portion of the piston rod, wherein the jack cylinder further comprises a rod end proximate an exposed end of the piston rod and a barrel end proximate a jack base;
a boot comprising:
a boot cavity operable to receive at least a portion of the jack cylinder;
a top end including an annular rim defining an annular rim opening; and
a bottom end including a barrel opening and an annular lip defining a planar surface; and
a flange disposed around at least a portion of the boot near the bottom end and positioned adjacent the annular lip of the boot, wherein:
the boot is flexible;
the annular rim is operable to retain at least a portion of the rod end of the jack cylinder within the boot cavity; and
the flange is operable to maintain contact between portions of the annular lip and the jack base.

2. The ingress prevention system of claim 1, further comprising:
a spring at least partially surrounding the barrel and the piston rod;
a head of the piston rod secured to the piston rod cap, wherein the piston rod cap is covering at least a portion of the spring, barrel, and piston rod; and
a rod opening of the piston rod cap being concentric with the annular rim opening.

3. The ingress prevention system of claim 2, wherein the annular rim opening is sized smaller than the piston rod cap to retain the rod end of the jack cylinder within the boot cavity.

4. The ingress prevention system of claim 3, wherein a bottom surface of the flange mates with the planar surface of the annular lip to maintain contact between the annular lip and the jack base.

5. The ingress prevention system of claim 1, further comprising:
a groove disposed on an inner surface of the barrel; and
a barrel seal disposed within the groove, the barrel seal operable to wipe debris and/or fluids from the piston rod as the piston rod reciprocates within the barrel.

6. The ingress prevention system of claim 1, further comprising a barrel seal secured to an end of the barrel, the barrel seal operable to wipe debris and/or fluids from the piston rod as the piston rod reciprocates within the barrel.

7. An ingress prevention system for use with jack cylinders, comprising:
a jack cylinder including a piston rod and a barrel, wherein the barrel is operable to receive at least a portion of the piston rod and securely fastened to a jack base with a threaded engagement;
a spring at least partially surrounding the barrel and the piston rod;
a boot comprising:
a boot cavity operable to receive at least a portion of the barrel, the piston rod, and the spring;
a top end including an annular rim defining an annular rim opening; and
a bottom end including a barrel opening and an annular lip, wherein:
the boot is flexible; and
a flange threadedly engaged with at least a portion of the barrel near the jack base.

8. The ingress prevention system of claim 7, wherein the annular rim is adjacent to a retaining ring and at least one boot seal, wherein the retaining ring and the at least one boot seal are operable to seal the top end of the boot.

9. The ingress prevention system of claim 7, wherein the flange includes a lip cavity disposed on an inner surface of the flange, the lip cavity operable to receive at least a portion of the annular lip.

10. The ingress prevention system of claim 7, wherein the barrel includes a port operable to regulate air pressure within the boot cavity.

11. The ingress prevention system of claim 10, further comprising a filter disposed within a hollow bore of the port.

12. The ingress prevention system of claim 7, further comprising:
a groove disposed on an inner surface of the barrel; and
a barrel seal disposed within the groove, the barrel seal operable to wipe debris and/or fluids from the piston rod as the piston rod reciprocates within the barrel.

13. The ingress prevention system of claim 7, further comprising a barrel seal secured to an end of the barrel, the barrel seal operable to wipe debris and/or fluids from the piston rod as the piston rod reciprocates within the barrel.

14. An ingress prevention system for use with jack cylinders, comprising:
a plurality of jack cylinders, each including a piston rod and a barrel, wherein the barrel is operable to receive at least a portion of the piston rod, wherein each of the plurality of jack cylinders further comprises a rod end proximate an exposed end of the piston rod and a barrel end proximate a jack base;
a boot comprising:
a boot cavity operable to receive at least a portion of each of the plurality of jack cylinders;
a top end including an annular rim defining a piston rod opening and a plate cavity disposed within the annular rim;
a plate disposed at least partially within the plate cavity of the annular rim; and
a bottom end including a barrel opening and an annular lip defining a planar surface, wherein:
the boot is flexible; and
a flange disposed around at least a portion of the boot and positioned adjacent the annular lip of the boot, the flange secured to the jack base with a plurality of fasteners.

15. The ingress prevention system of claim 14, further comprising:
a plurality of springs each at least partially surrounding the barrels and the piston rods; and
a plurality of piston rod caps, the plurality of piston rod caps secured to a head of each of the piston rods and covering at least a portion of the springs, the barrels, and the piston rods.

16. The ingress prevention system of claim 14, wherein the plate includes a plurality of openings operable to receive each of the exposed ends of the plurality of jack cylinders.

17. The ingress prevention system of claim 14, further comprising:
a groove disposed on an inner surface of each of the barrels; and
a barrel seal disposed within the groove, the barrel seal operable to wipe debris and/or fluids from the piston rods as the piston rods reciprocate within the barrels.

18. The ingress prevention system of claim 14, further comprising a barrel seal secured to an end of each of the barrels, the barrel seal operable to wipe debris and/or fluids from the piston rods as the piston rods reciprocate within the barrels.

19. An ingress prevention system for use with jack cylinders, comprising:
a jack cylinder including a piston rod and a barrel, wherein the barrel is operable to receive at least a portion of the piston rod;
a spring at least partially surrounding the barrel and the piston rod;
a piston rod cap secured to a head of the piston rod and covering at least a portion of the spring, the barrel, and the piston rod;
a boot disposed between the spring and the piston rod, the boot comprising:
a boot cavity operable to receive at least a portion of the barrel and the piston rod,
a top end including a piston rod opening, the top end operable to retain at least a portion of the piston rod within the boot cavity, and
a bottom end including a barrel opening operable to at least partially receive the barrel, the bottom end operable to retain at least a portion of the barrel within the boot cavity.

20. The ingress prevention system of claim 19, wherein the boot includes a flexible portion near the top end and a stiff portion near the bottom end having a clamp to secure the bottom end of the boot to the barrel.

21. The ingress prevention system of claim 19, wherein the piston rod cap comprises a shield, a retaining ring, and a retaining clip, wherein the retaining clip is operable to secure the retaining ring to the piston rod.

22. The ingress prevention system of claim 19, further comprising:
a groove disposed on an inner surface of the barrel; and
a barrel seal disposed within the groove, the barrel seal operable to wipe debris and/or fluids from the piston rod as the piston rod reciprocates within the barrel.
